(19) United States
(12) Patent Application Publication
(10) Pub. No.: US 2025/0116501 A1
(43) Pub. Date: Apr. 10, 2025

(54) METHOD OF CALCULATING OPTICAL AERIAL IMAGE

(71) Applicant: National Tsing Hua University, Hsinchu City (TW)

(72) Inventors: Tsai-Sheng Gau, Hsinchu City (TW); Burn Jeng Lin, Hsinchu City (TW); Anthony Yen, Hsinchu City (TW); Chun-Kuang Chen, Hsinchu City (TW); Fu-Hsiang Ko, Hsinchu City (TW); Po-Hsiung Chen, Hsinchu City (TW)

(73) Assignee: National Tsing Hua University, Hsinchu City (TW)

(21) Appl. No.: 18/629,956

(22) Filed: Apr. 9, 2024

(30) Foreign Application Priority Data
Oct. 4, 2023 (TW) 112138145

(51) Int. Cl. G01B 9/02; G06F 17/14

(52) U.S. Cl. CPC G01B 9/02084; G06F 17/142

(57) ABSTRACT

A method for calculating optical aerial images. The method includes following steps. A first pattern distribution in a spatial domain is multiplied by a scaling constant to scale the first pattern distribution to generate a second pattern distribution. A fast Fourier transform is performed on the second pattern distribution to generate a first spatial frequency spectrum distribution in a spatial frequency domain. The first spatial frequency spectrum distribution is multiplied by a pupil function to generate a second spatial frequency spectrum distribution. An inverse fast Fourier transform is performed on the second spatial frequency spectrum distribution to generate a first diffraction image distribution in the spatial domain. The first diffraction image distribution is divided by a scaling constant to scale the first diffraction image distribution to generate a second diffraction image distribution.

### CROSS-REFERENCE TO RELATED APPLICATION

This application claims the priority benefit of Taiwan application serial no. 112138145, filed on Oct. 4, 2023. The entirety of the above-mentioned patent application is hereby incorporated by reference herein and made a part of this specification.

### BACKGROUND

### Technical Field

The invention relates to a method of calculating optical aerial image, and particularly relates to a method of replacing a Fourier transform with a fast Fourier transform when a wavelength is a non-integer.

### Description of Related Art

Optical aerial image calculation and simulation are an important part of lithography technology in semiconductor forward-looking technology, such as optical proximity correction (OPC), source mask optimization (SMO), inverse lithography, etc., are all important technologies therein. In terms of forward-looking semiconductors, each chip contains billions of semiconductor components. When the above-mentioned techniques are applied, calculations must be completed within days and must be performed with high accuracy. Therefore, it is necessary to be able to quickly complete these optical aerial image calculations and simulations. A core of optical calculation includes Fourier transform (FT). A numerical calculation of the conventional Fourier transform is quite time-consuming, and a calculation speed is slow. On the other hand, fast Fourier transform (FFT) may solve the problem of calculation efficiency of the numerical calculation of the Fourier transform, but since a wavelength when performing FFT must be an exponential multiple of 2, while a wavelength of semiconductor technology is a number like 248 nm or 193 nm, etc., the FFT technology cannot be directly applied to optical aerial image calculations and simulations.

### SUMMARY

The invention provides a method for calculating optical aerial images, the method includes following steps. A first pattern distribution in a spatial domain is multiplied by a scaling constant to scale the first pattern distribution to generate a second pattern distribution. A fast Fourier transform is performed on the second pattern distribution to generate a first spatial frequency spectrum distribution in a spatial frequency domain. The first spatial frequency spectrum distribution is multiplied by a pupil function to generate a second spatial frequency spectrum distribution. An inverse fast Fourier transform is performed on the second spatial frequency spectrum distribution to generate a first diffraction image distribution in the spatial domain. The first diffraction image distribution is divided by the scaling constant to scale the first diffraction image distribution to generate a second diffraction image distribution.

According to some embodiments of the invention, a relationship between the first pattern distribution and the second pattern distribution is expressed as:

$${A}^{′} ( x , y ) = A ( \frac{x}{σ} , \frac{y}{σ} ) ,$$

where A(x,y) is the first pattern distribution, A′(x,y) is the second pattern distribution, and σ is the scaling constant.

According to some embodiments of the invention, the scaling constant is expressed as:

$$σ = \frac{q}{u} , u = {2}^{n} , q = \frac{λ}{ab} ,$$

where σ is the scaling constant, u is an n^{th} power of 2, where n is a positive integer, λ is a wavelength of light emitted by the optical system, a is a unit length of the spatial domain, and b is a unit length of the spatial frequency domain.

According to some embodiments of the invention, u is an integer closest to q. U is any integer that is an exponential multiple of 2, and the closest is an embodiment.

According to some embodiments of the invention, a relationship between the second pattern distribution and the first spatial frequency spectrum distribution is expressed as:

$$B ( l b , mb ) = {\sum }_{r = 0}^{N - 1} {\sum }_{s = 0}^{N - 1} {A}^{′} ( ra , sa ) exp ( - 2 π i \frac{( r l + m s )}{u} )$$

where B(lb, mb) is the first spatial frequency spectrum distribution, A′(ra, sa) is the second pattern distribution, where r, s, l, m are positive integers or 0, ra and sa are coordinates in the spatial domain, lb and mb are coordinates in the spatial frequency domain,
where u is expressed as: u=q/σ, where N is a number of pixels on a coordinate axis of the spatial domain.

According to some embodiments of the invention, a relationship between the first spatial frequency spectrum distribution and the second spatial frequency spectrum distribution is expressed as:

B′(lb, mb)=P(lb, mb)B(lb, mb),
where B(lb, mb) is the first spatial frequency spectrum distribution, B′(lb, mb) is the second spatial frequency spectrum distribution, P(lb, mb) is the pupil function, and lb, mb are coordinates in the spatial frequency domain.

According to some embodiments of the invention, the pupil function is expressed as:

$$P ( l b , mb ) = \{ \begin{matrix}= 1 , & {( {( l b )}^{2} + {( mb )}^{2} )}^{1 / 2} \leq \frac{NA}{λ} \\ = 0 , & {( {( l b )}^{2} + {( mb )}^{2} )}^{1 / 2} > \frac{NA}{λ}\end{matrix} ,$$

where NA is a numerical aperture of a projection lens of the optical system, and λ is a wavelength of light emitted by the optical system.

According to some embodiments of the invention, the numerical aperture is expressed as:

NA=n sin θ
where n is a refractive index of the projection lens, and θ is the maximum angle between the light and an optical axis of the projection lens when the light is incident on the projection lens.

According to some embodiments of the invention, a relationship between the second spatial frequency spectrum distribution and the first diffraction image distribution is expressed as:

$${C}^{′} ( ra , sa ) = {\sum }_{l = 0}^{N - 1} {\sum }_{m = 0}^{N - 1} {B}^{′} ( l b , mb ) exp ( 2 π i \frac{( r l + m s )}{u} ) ,$$

where B′(lb, mb) is the second spatial frequency spectrum distribution, C′(ra, sa) is the first diffraction image distribution, where r, s, l, m are positive integers or 0, ra, sa are coordinates in the spatial domain, lb and mb are coordinates in the spatial frequency domain, where u=q/σ, q is expressed as: q=λ/ab, where a is a unit length of the spatial domain, b is a unit length of the spatial frequency domain, λ is a wavelength of light emitted by the optical system, and N is a number of pixels on a coordinate axis of the spatial domain.

According to some embodiments of the invention, a relationship between the

first diffraction image distribution and the second diffraction image distribution is expressed as:

(x, y)=C′(σx, σy)
where C′(σx, σy) is the first diffraction image distribution, C(x, y) is the second diffraction image distribution, and σ is the scaling constant.

Based on the above description, by scaling the pattern distribution at a specific ratio, the scaled pattern distribution may adopt fast Fourier transform to accelerate calculation of optical aerial images.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of a conventional method for calculating an optical aerial image.

FIG. 2 is a flowchart of a method for calculating an optical aerial image according to an embodiment of the invention.

FIG. 3A is a schematic diagram of a pattern distribution according to an embodiment of the invention.

FIG. 3B is a schematic diagram of a first pattern distribution and a second pattern distribution according to an embodiment of the invention.

FIG. 3C is an optical aerial image obtained through fast Fourier transform based on the pattern distribution in FIG. 3A.

FIG. 3D is an optical aerial image obtained through Fourier transform based on the pattern distribution in FIG. 3A.

FIG. 3E shows intensity distributions of optical aerial images obtained through a fast Fourier transform method and a Fourier transform method according to an embodiment of the invention.

FIG. 4A is a schematic diagram of a pattern distribution according to another embodiment of the invention.

FIG. 4B is a schematic diagram of a first pattern distribution and a second pattern distribution according to another embodiment of the invention.

FIG. 4C is an optical aerial image obtained through fast Fourier transform based on the pattern distribution in FIG. 4A.

FIG. 4D is an optical aerial image obtained through Fourier transform based on the pattern distribution in FIG. 4A.

FIG. 4E shows intensity distributions of optical aerial images obtained through the fast Fourier transform method and the Fourier transform method according to an embodiment of the invention.

### DESCRIPTION OF THE EMBODIMENTS

In a semiconductor manufacturing process, a photolithography process is a very important link. By simulating a photomask, an optical aerial image generated by the photomask during the photolithography process may be calculated, and a design of the photomask is evaluated to confirm an effect of the photomask before actually producing the photomask, so as to reduce possible errors.

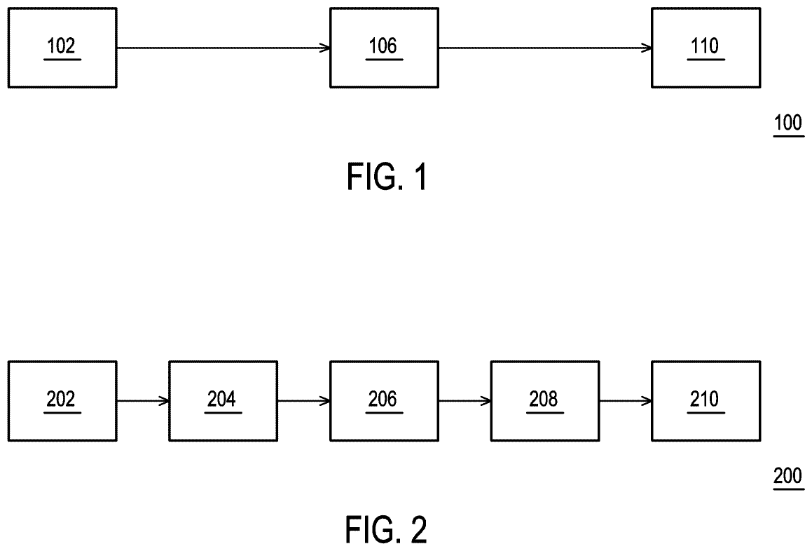

FIG. 1 is a flowchart of a conventional method for calculating an optical aerial image. As shown in FIG. 1, a method 100 includes the following steps. A wavelength of an incident light and a numerical aperture of an optical system are given parameters.

Step 102: a pattern distribution is provided in a spatial domain. Where, the pattern distribution may be expressed as A(x,y), which corresponds to a mask pattern of a mask to be simulated and located in the optical system.

Step 106: Fourier transform is performed on the pattern distribution to generate a spatial frequency spectrum distribution located in a spatial frequency domain. A relationship between the pattern distribution and the spatial frequency spectrum distribution may be expressed as:

$$B ( {k}_{x} , {k}_{y} ) = {\int }_{- ∞}^{∞} {\int }_{- ∞}^{∞} A ( x , y ) exp ( - 2 π i ( {k}_{x} x + {k}_{y} y ) ) d x d y \qquad ( 1 )$$

where, B(kₓ,k_{y}) is the spatial frequency spectrum distribution, and A(x,y) is the pattern distribution.

In step 108, the spatial frequency spectrum distribution is multiplied by a pupil function, and an inverse fast Fourier transform is performed to generate a diffraction image distribution located in the spatial domain. A relationship between the spatial frequency spectrum distribution and the diffraction image distribution may be expressed as:

$$C ( x , y ) = {\int }_{- ∞}^{∞} {\int }_{- ∞}^{∞} P ( {k}_{x} , {k}_{y} ) B ( {k}_{x} , {k}_{y} ) exp ( 2 π i ( {k}_{x} x + {k}_{y} y ) ) d {k}_{x} d {k}_{y} \qquad ( 2 )$$

where B(kₓ,k_{y}) is the spatial frequency spectrum distribution, P(kₓ,k_{y}) is the pupil function, and C(x,y) is the diffraction image distribution.

The pupil function P(kₓ,k_{y}) of equation (2) may be expressed as:

$$P ( {k}_{x} , {k}_{y} ) = \{ \begin{matrix}= 1 , & {( {k}_{x}^{2} + {k}_{y}^{2} )}^{1 / 2} \leq \frac{NA}{λ} \\ = 0 , & {( {k}_{x}^{2} + {k}_{y}^{2} )}^{1 / 2} > \frac{NA}{λ}\end{matrix} \qquad ( 3 )$$

where NA is the numerical aperture of a projection lens of the optical system, and λ is a wavelength of light emitted by the optical system.

Through the method 100 shown in FIG. 1, the Fourier transform may be used

to calculate the given pattern distribution to obtain its corresponding optical aerial image, i.e., a diffraction pattern image simulation result. However, in practical applications, deep loop calculations are required when using computers to perform calculations related to the Fourier transform, so that a considerable amount of calculation time is required. Therefore, by using computers to perform calculations related to Fourier transforms, computation efficiency is significantly reduced.

In order to quickly calculate the Fourier transform, a common approach is to perform fast Fourier transform (FFT). Taking the aforementioned step 106 as an example, if the Fourier transform of equation (3) in step 106 is replaced by the fast Fourier transform, a relationship between the pattern distribution and the spatial frequency spectrum distribution may be expressed as:

$$B ( {k}_{x} , {k}_{y} ) = {\sum }_{m = 0}^{N - 1} {\sum }_{n = 0}^{N - 1} A ( x , y ) exp ( - \frac{2 π i}{λ} ( {k}_{x} x + {k}_{y} y ) ) \qquad ( 4 )$$

where λ is the wavelength of light emitted by the optical system

However, to use the fast Fourier transform for calculation, one of the important conditions is that a value of λ needs to be a positive integer power of 2. But in the semiconductor manufacturing process, the wavelength of the incident light may be 248 nm or 193 nm or other values. Therefore, if the fast Fourier transform is needed for calculation, the pattern distribution A(x,y) needs to be scaled so that the scaled pattern distribution may be calculated by using the fast Fourier transform.

FIG. 2 is a flowchart of a method for calculating an optical aerial image according to an embodiment of the invention. A wavelength of incident light and a numerical aperture of the optical system are given parameters.

As shown in FIG. 2, a method 200 includes following steps.

In step 202, a first pattern distribution in a spatial domain is provided. Where, the first pattern distribution may be expressed as A(x,y), which corresponds to a mask pattern of a mask to be simulated and located in the optical system.

In step 204, the first pattern distribution in the spatial domain is multiplied by a scaling constant to scale the first pattern distribution to generate a second pattern distribution.

To be specific, a relationship between the first pattern distribution and the second pattern distribution may be expressed as:

$${A}^{′} ( x , y ) = A ( \frac{x}{σ} , \frac{y}{σ} ) , \qquad ( 5 )$$

where A(x,y) is the first pattern distribution, A′(x,y) is the second pattern distribution, and σ is the scaling constant.
where, the scaling constant σ of equation (5) may be represented as:

$$σ = \frac{q}{u} , \qquad ( 6 )$$

$$u = {2}^{n} , \qquad ( 7 )$$

$$q = \frac{λ}{a b} , \qquad ( 8 )$$

where σ is the scaling constant, u is an n^{th} power of 2, where n is a positive integer, λ is a wavelength of light emitted by the optical system, a is a unit length of the spatial domain, and b is a unit length of the spatial frequency domain.

For example, in an embodiment, the wavelength λ is 193 nm. In the spatial domain, there are 64 pixels in both of a first direction and a second direction perpendicular to the first direction. The unit length a of the spatial domain is 25 nm. In the spatial frequency domain, there are 64 pixels in both of the first direction and the second direction perpendicular to the first direction. In other words, there is the same number of pixels in each direction of the spatial domain and the spatial frequency domain. Generally, a coordinate range of each direction in the spatial frequency domain is −2 to +2, so that the unit length b of the spatial frequency domain is 4/64 nm⁻¹.

At this time, according to formula (8), it is obtained that

$$q = \frac{λ}{a b} = \frac{193}{25 * \frac{4}{64}} = 123.55 nm .$$

In this case, the scaling constant o may be obtained through an equation (6): σ=q/u, where u is a positive integer power of 2.

In some embodiments, u is an integer closest to q so that the scaling constant σ will not be too large or too small. In the embodiment, since q=123.52 and the positive integer closest to q and the positive integer power of 2 is 128, so that u=128 is selected. But choosing other positive integer powers of 2, such as 64 or 256 or other positive integer powers of 2 will not affect the calculation result.

When u=128, q=123.52, according to equation (6), the scaling constant σ is:

$$σ = \frac{q}{u} = \frac{123.52}{128} = 0.965 .$$

Therefore, the first pattern distribution A(x,y) is scaled to obtain a second pattern distribution A′(x,y), i.e., the equation (5).

$${A}^{′} ( x , y ) = A ( \frac{x}{σ} , \frac{y}{σ} ) \qquad ( 5 )$$

In this step, only the first pattern distribution A(x,y) is scaled so that the scaled second pattern distribution A′(x,y) may be subjected to the fast Fourier transformed without changing the characteristics of the original first pattern distribution A(x,y).

In step 206: a fast Fourier transform is performed on the second pattern distribution to generate a first spatial frequency spectrum distribution in a spatial frequency domain.

To be specific, a relationship between the second pattern distribution and the first spatial frequency spectrum distribution may be expressed as:

$$B ( l b , mb ) = {\sum }_{r = 0}^{N - 1} {\sum }_{s = 0}^{N - 1} {A}^{′} ( ra , sa ) exp ( - 2 π i \frac{( r l + m s )}{u} ) , \qquad ( 9 )$$

where B(lb, mb) is the first spatial frequency spectrum distribution, A′(ra, sa) is the second pattern distribution, where r, s, l, m are positive integers or 0, ra and sa are coordinates in the spatial domain, lb and mb are coordinates in the spatial frequency domain, where u may be expressed as: u=q/o, where N is a number of pixels on a coordinate axis of the spatial domain.

Therefore, through step 206, the scaled second pattern distribution A′(ra, sa) in the spatial domain may be converted into the first spatial frequency spectrum distribution B(lb, mb) in the spatial frequency domain.

In step 208, the first spatial frequency spectrum distribution is multiplied by a pupil function to generate a second spatial frequency spectrum distribution. An inverse fast Fourier transform is performed on the second spatial frequency spectrum distribution to generate a first diffraction image distribution in the spatial domain.

To be specific, a relationship between the first spatial frequency spectrum distribution and the second spatial frequency spectrum distribution may be expressed as:

$${B}^{′} ( lb , mb ) = P ( lb , mb ) B ( lb , mb ) , \qquad ( 10 )$$

where B(lb, mb) is the first spatial frequency spectrum distribution, B′(lb, mb) is the second spatial frequency spectrum distribution, P(lb, mb) is the pupil function, and lb, mb are coordinates in the spatial frequency domain.

Where, the pupil function of equation (10) may be represented as:

$$P ( l b , mb ) = \{ \begin{matrix}= 1 , & {( {( l b )}^{2} + {( mb )}^{2} )}^{1 / 2} \leq \frac{NA}{λ} \\ = 0 , & {( {( l b )}^{2} + {( mb )}^{2} )}^{1 / 2} > \frac{NA}{λ}\end{matrix} , \qquad ( 11 )$$

where NA is a numerical aperture of a projection lens of the optical system, and λ is a wavelength of light emitted by the optical system.

Here, the numerical aperture of equation (11) may be represented as:

$$N A = n sin θ , \qquad ( 12 )$$

where n is a refractive index of the projection lens, and θ is the maximum angle between the light and an optical axis of the projection lens when the light is incident on the projection lens. Therefore, the numerical aperture has limited an incident angle of light that may pass through the lens.

The pupil function P(lb, mb) in equation (11) functions as a low-pass filter, which only allows low-frequency components

$$( i . e . , {( {( l b )}^{2} + {( mb )}^{2} )}^{1 / 2} \leq \frac{NA}{λ} )$$

smaller than a certain threshold in the spatial frequency domain to pass through to filter out unnecessary high-frequency components

$$( i . e . , {( {( l b )}^{2} + {( mb )}^{2} )}^{1 / 2} > \frac{NA}{λ} ) ) .$$

In step 210: the first diffraction image distribution is divided by the scaling constant to scale the first diffraction image distribution to generate a second diffraction image distribution.

To be specific, a relationship between the second spatial frequency spectrum distribution and the first diffraction image distribution may be expressed as:

$${C}^{′} ( ra , sa ) = {\sum }_{l = 0}^{N - 1} {\sum }_{m = 0}^{N - 1} {B}^{′} ( l b , mb ) exp ( 2 π i \frac{( r l + m s )}{u} ) , \qquad ( 13 )$$

where B′(lb, mb) is the second spatial frequency spectrum distribution, C′(ra, sa) is the first diffraction image distribution, where r, s, l, m are positive integers or 0, ra, sa are coordinates in the spatial domain, lb and mb are coordinates in the spatial frequency domain, where u=q/σ, q is expressed as: q=λ/ab, where a is a unit length of the spatial domain, b is a unit length of the spatial frequency domain, λ is a wavelength of light emitted by the optical system, and N is a number of pixels on a coordinate axis of the spatial domain.

According to some embodiments of the invention, a relationship between the first diffraction image distribution and the second diffraction image distribution may be expressed as:

$$C ( x , y ) = {C}^{′} ( σ x , σ y ) , \qquad ( 14 )$$

where C(σx, σy) is the first diffraction image distribution, C(x, y) is the second diffraction image distribution, and σ is the scaling constant.

Therefore, the second diffraction image distribution C(x, y) obtained in step 210 of the method 200 is a diffraction pattern image simulation result obtained for the first pattern distribution A(x, y) in step 202 under the given wavelength and numerical aperture. It may be determined whether modifications need to be made to the first pattern distribution A(x, y) based on the second diffraction image distribution C(x, y), or whether a photomask for the optical system is made based on the first pattern distribution A(x, y).

In some embodiments, an intensity distribution I(x, y) generated by the second diffraction image distribution C(x, y) may be further obtained, i.e.,

$$I ( x , y ) = {C}^{*} ( x , y ) \times C ( x , y ) , \qquad ( 15 )$$

Where, I(x, y) is the intensity distribution, and C*(x, y) is a conjugate complex of the second diffraction image distribution C(x, y).

In some embodiments, the method 200 may be implemented by a computer system. In some embodiments, the computer system performs the functions of the method 200 of FIG. 2. In some embodiments, all processes, methods and/or operations of the method 200 of FIG. 2 or a part thereof may be implemented by using computer hardware and computer programs executed thereon. In some embodiments, the computer system includes a computer, and the computer includes a CD-ROM (for example, CD-ROM or DVD-ROM) drive and disk drive, a keyboard, a mouse, and a monitor.

In some embodiments, in addition to optical disk drives and disk drives, the computer also has: one or a plurality of processors, such as a microprocessing unit (MPU); programs stored in ROM (such as a boot program); a random access memory (RAM), which is connected to the MPU and application commands are temporarily stored therein and which provides a temporary storage area; a hard disk, where the application, system programs and data are stored; and a bus, which is connected MPU, ROM and similar. It should be noted that the computer may include a network card (not shown) for providing connection of a LAN.

The program for causing the computer system to execute the functions in the foregoing embodiments may be stored in an optical disk or magnetic disk inserted into the optical disk drive or magnetic disk drive, and transferred to the hard disk. Alternatively, the program may be transferred to the computer via a network (not shown) and stored on the hard drive. At a time of execution, the program is loaded into RAM. The program may be loaded from a CD or disk or directly from the Internet. The program does not necessarily have to include, for example, an operating system (OS) or a third party program to cause the computer to perform the functions in the aforementioned embodiments. The program may contain only a command portion to call an appropriate function (module) in a controlled mode and obtain a desired result.

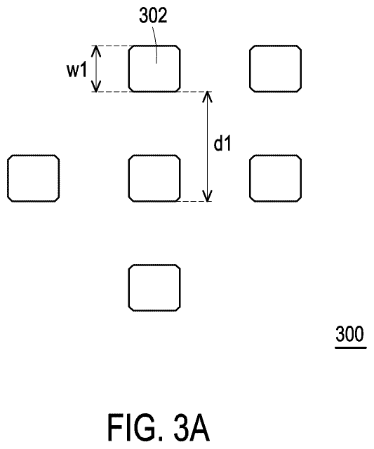

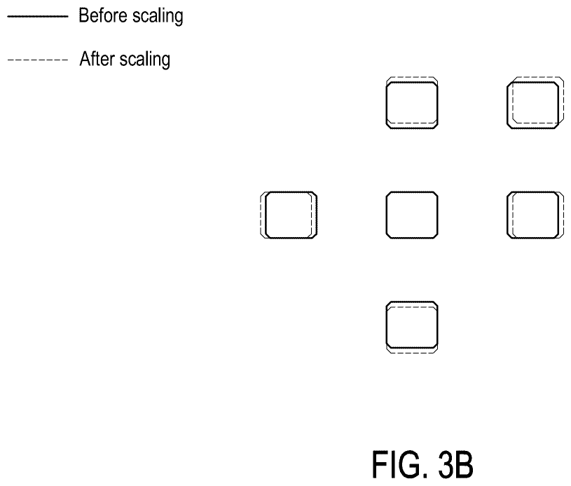

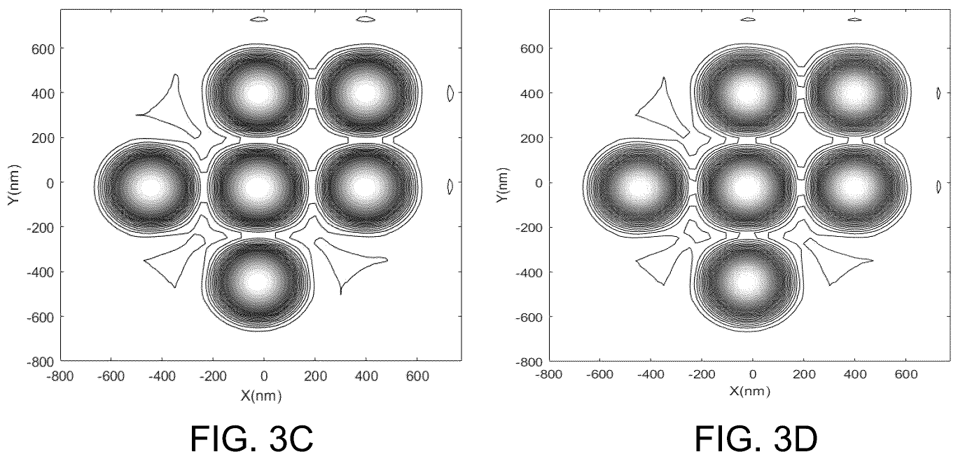

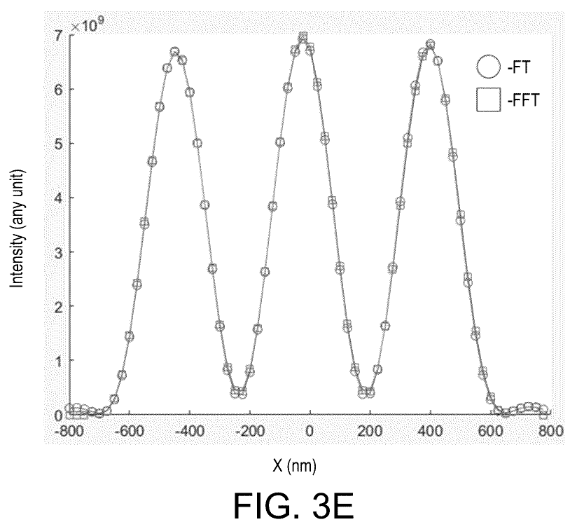

FIG. 3A to FIG. 3E illustrate comparison of a calculation method based on fast Fourier transform provided by the invention (such as the method 200 in FIG. 2) and a calculation method based on Fourier transform in the prior art (such as the method 100 of FIG. 1).

FIG. 3A is a schematic diagram of a pattern distribution according to an embodiment of the invention. In the embodiment, a first pattern distribution 300 includes a plurality of square holes 302. A side length of a hole is w1, and a distance between the holes is d1. In the embodiment, w1 is 150 nm and d1 is 425 nm, but the disclosure is not limited thereto. The first pattern distribution 300 here is equivalent to the first pattern distribution in step 202.

In addition, in the embodiment, the wavelength λ of the incident light is 193 nm, the numerical aperture NA is 0.5, and the scaling constant (i.e., a partial coherence parameter) σ is 0.8.

FIG. 3B is a schematic diagram of a first pattern distribution and a second pattern distribution according to an embodiment of the invention. In FIG. 3B, the calculation of step 204 in FIG. 2 is performed on the first pattern distribution 300 of FIG. 3A. Specifically, the first pattern distribution 300 of FIG. 3A is multiplied by the scaling constant o to scale the first pattern distribution 300 to generate a second pattern distribution 310. In FIG. 3B, a solid line part is the first pattern distribution 300 before scaling, and a dotted line part is the second pattern distribution 310 after scaling.

FIG. 3C is an optical aerial image obtained through fast Fourier transform based on the pattern distribution in FIG. 3A. The optical aerial image shown in FIG. 3C is obtained by performing steps 206, 208 and 210 of FIG. 2 on the second pattern distribution 310 shown in FIG. 3B. Specifically, a fast Fourier transform is performed on the second pattern distribution 310 to generate a first spatial frequency spectrum distribution located in the spatial frequency domain. The first spatial frequency spectrum distribution is multiplied by a pupil function to generate a second spatial frequency spectrum distribution. An inverse fast Fourier transform is performed on the second spatial frequency spectrum distribution to generate a first diffraction image distribution located in the spatial domain. The first diffraction image distribution is divided by a scaling constant to scale the first diffraction image distribution to generate a second diffraction image distribution. The optical aerial image in FIG. 3C is the second diffraction image distribution obtained in step 210.

FIG. 3D is an optical aerial image obtained through Fourier transform based on the pattern distribution in FIG. 3A. The optical aerial image shown in FIG. 3D is obtained by performing step 102, step 106 and step 110 of FIG. 1 on the first pattern distribution 300 shown in FIG. 3A. Specifically, the Fourier transform is performed on the first pattern distribution 300 to generate a spatial frequency spectrum distribution located in the spatial frequency domain. The spatial frequency spectrum distribution is multiplied by a pupil function and an inverse Fourier transform is performed to generate a diffraction image distribution in the spatial domain. The optical aerial image in FIG. 3D is the diffraction image distribution obtained in step 110.

FIG. 3E shows intensity distributions I(x,y) of optical aerial images obtained through a fast Fourier transform method and a Fourier transform method according to an embodiment of the invention. In order to compare FIG. 3C and FIG. 3D, cross sections are respectively made along center points of the images in FIG. 3C and FIG. 3D, and the intensity distributions of the corresponding diffraction image distributions corresponding to FIG. 3C and FIG. 3D are calculated, so as to compare the intensity distributions corresponding to FIG. 3C and FIG. 3D, i.e., FIG. 3E. As shown in FIG. 3E, compared with the conventional Fourier transform method, the scaling-fast Fourier transform method used in the invention obtains the same intensity distribution. The intensities of the overall images (FIG. 3C and FIG. 3D) are respectively integrated to obtain respective total intensities. An error

$$( Error = \frac{{I}_{F F T} - {I}_{F T}}{{I}_{F T}} )$$

between the intensity (I_{FFT}) of the scaling-fast Fourier transform method of the invention and the total intensity (I_{FT}) of the conventional Fourier transform method is 3.2%. Therefore, the total intensities obtained by both methods are consistent.

However, there is a considerable difference in the spent calculation time. By using the conventional Fourier transform method, the required calculation time is 1540 seconds. By using the scaling-fast Fourier transform method provided by the invention, the required calculation time is 0.22 seconds, and a difference there between is about 7700 times.

Therefore, by using the scaling-fast Fourier transform method provided by the invention, the same result as the conventional Fourier transform method may be quickly obtained, and the calculation speed is about 7700 times faster, which may effectively save computing resources and improve calculation efficiency.

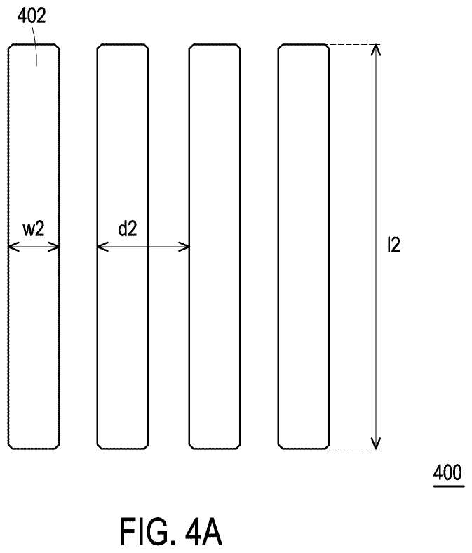

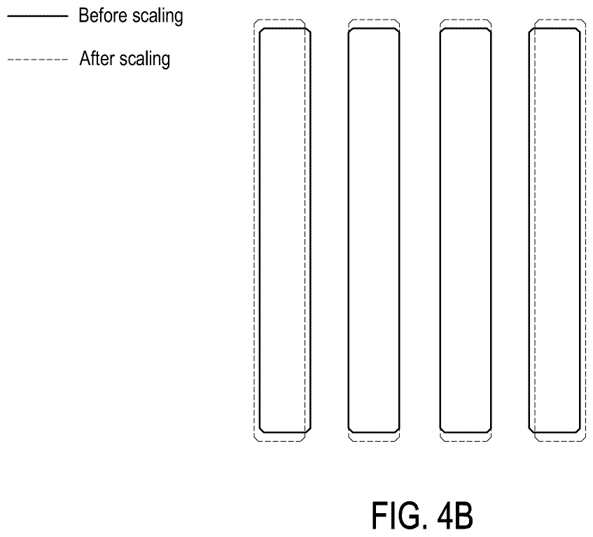

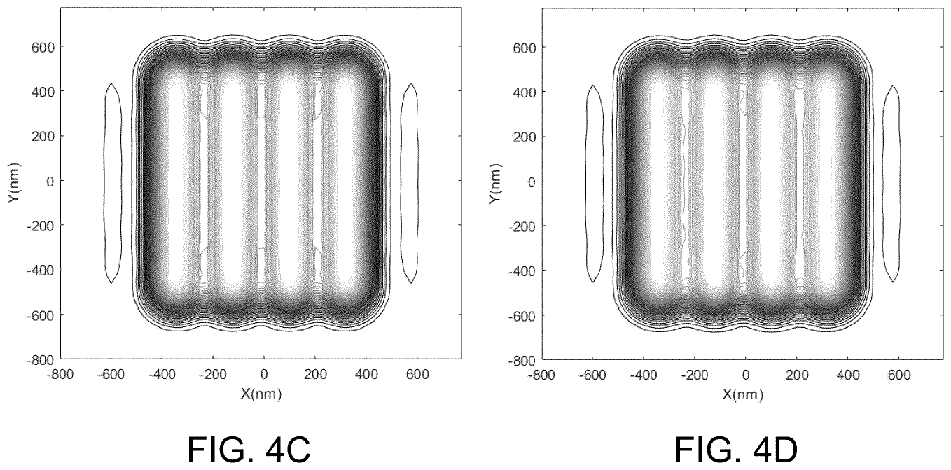

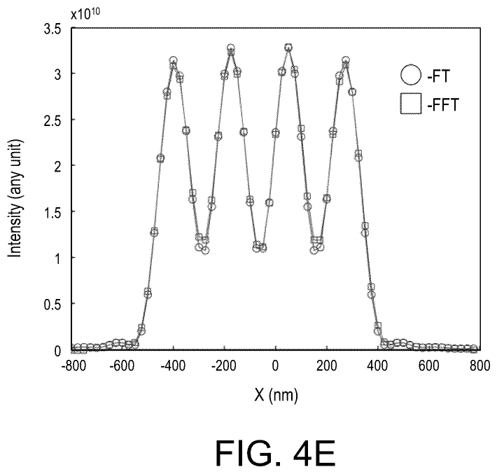

FIG. 4A to FIG. 4E illustrate another comparison between the calculation method based on fast Fourier transform provided by the invention (such as the method 200 in FIG. 2) and the calculation method based on Fourier transform in the prior art (such as the method in FIG. 1 100).

FIG. 4A is a schematic diagram of a pattern distribution according to another embodiment of the invention. In the embodiment, a first pattern distribution 400 includes a plurality of rectangular holes 402. A width of the hole is w2, a length of the hole is l2, and a distance between the holes is d2. In the embodiment, w2 is 100 nm, l2 is 1000 nm, and d2 is 225 nm, but the disclosure is not limited thereto. The first pattern distribution 400 here is equivalent to the first pattern distribution in step 202.

In addition, in the embodiment, the wavelength λ of the incident light is 193 nm, the numerical aperture NA is 0.7, and the scaling constant (i.e., partial coherence parameter) σ is 0.8.

FIG. 4B is a schematic diagram of a first pattern distribution and a second pattern distribution according to another embodiment of the invention. In FIG. 4B, the calculation of step 204 of FIG. 2 is performed on the first pattern distribution 400 of FIG. 4A. Specifically, the first pattern distribution 400 of FIG. 4A is multiplied by the scaling constant σ to scale the first pattern distribution 400 to generate a second pattern distribution 410. In FIG. 4B, a solid line part is the first pattern distribution 400 before scaling, and a dotted line part is the second pattern distribution 410 after scaling.

FIG. 4C is an optical aerial image obtained through fast Fourier transform based on the pattern distribution in FIG. 4A. The optical aerial image shown in FIG. 4C is obtained by performing steps 206, 208 and 210 of FIG. 2 on the second pattern distribution 410 shown in FIG. 4B. Specifically, a fast Fourier transform is performed on the second pattern distribution 410 to generate a first spatial frequency spectrum distribution located in the spatial frequency domain. The first spatial frequency spectrum distribution is multiplied by a pupil function to generate a second spatial frequency spectrum distribution. An inverse fast Fourier transform is performed on the second spatial frequency spectrum distribution to generate a first diffraction image distribution located in the spatial domain. The first diffraction image distribution is divided by a scaling constant to scale the first diffraction image distribution to generate a second diffraction image distribution. The optical aerial image in FIG. 4C is the second diffraction image distribution obtained in step 210.

FIG. 4D is an optical aerial image obtained through Fourier transform based on the pattern distribution in FIG. 4A. The optical aerial image shown in FIG. 4D is obtained by performing step 102, step 106 and step 110 of FIG. 1 on the first pattern distribution 400 shown in FIG. 4A. Specifically, the Fourier transform is performed on the first pattern distribution 400 to generate a spatial frequency spectrum distribution located in the spatial frequency domain. The spatial frequency spectrum distribution is multiplied by a pupil function and an inverse Fourier transform is performed to generate a diffraction image distribution in the spatial domain. The optical aerial image in FIG. 4D is the diffraction image distribution obtained in step 110.

FIG. 4E shows intensity distributions I(x,y) of optical aerial images obtained through the fast Fourier transform method and the Fourier transform method according to an embodiment of the invention. In order to compare FIG. 4C and FIG. 4D, cross sections are respectively made along center points of the images in FIG. 4C and FIG. 4D, and the intensity distributions of the corresponding diffraction image distributions corresponding to FIG. 4C and FIG. 4D are calculated, so as to compare the intensity distributions corresponding to FIG. 4C and FIG. 4D, i.e., FIG. 4E. As shown in FIG. 4E, compared with the conventional Fourier transform method, the scaling-fast Fourier transform method used in the invention obtains the same intensity distribution. The intensities of the overall images (FIG. 4C and FIG. 4D) are respectively integrated to obtain respective total intensities. An error

$$( Error = \frac{{I}_{F F T} - {I}_{F T}}{{I}_{F T}} )$$

between the intensity (I_{FFT}) of the scaling-fast Fourier transform method of the invention and the total intensity (I_{FT}) of the conventional Fourier transform method is 2.85%. Therefore, the total intensities obtained by both methods are consistent.

However, there is a considerable difference in the spent calculation time. By using the conventional Fourier transform method, the required calculation time is 1560 seconds. By using the scaling-fast Fourier transform method provided by the invention, the required calculation time is 0.24 seconds, and a difference there between is about 6500 times.

Therefore, by using the scaling-fast Fourier transform method provided by the invention, the same result as the conventional Fourier transform method may be quickly obtained, and the calculation speed is about 6500 times faster, which may effectively save computing resources and improve calculation efficiency.

In summary, by scaling the pattern distribution at a specific ratio, the scaled pattern distribution may adopt fast Fourier transformation to accelerate the calculation of the optical aerial images.

What is claimed is:

1. A method for calculating optical aerial images, comprising:
multiplying a first pattern distribution in a spatial domain by a scaling constant to scale the first pattern distribution to generate a second pattern distribution;
performing a fast Fourier transform on the second pattern distribution to generate a first spatial frequency spectrum distribution in a spatial frequency domain;
multiplying the first spatial frequency spectrum distribution by a pupil function to generate a second spatial frequency spectrum distribution;
performing an inverse fast Fourier transform on the second spatial frequency spectrum distribution to generate a first diffraction image distribution in the spatial domain; and
dividing the first diffraction image distribution by the scaling constant to scale the first diffraction image distribution to generate a second diffraction image distribution.

2. The method as claimed in claim 1, wherein a relationship between the first pattern distribution and the second pattern distribution is expressed as:
$${A}^{′} ( x , y ) = A ( \frac{x}{σ} , \frac{y}{σ} ) ,$$
wherein A(x,y) is the first pattern distribution, A′(x,y) is the second pattern distribution, and σ is the scaling constant.

3. The method as claimed in claim 2, wherein the scaling constant is expressed as:
$$σ = \frac{q}{u} , u = {2}^{n} , q = \frac{λ}{ab} ,$$
wherein σ is the scaling constant, u is an n^{th} power of 2, wherein n is a positive integer, λ is a wavelength of a light emitted by an optical system, a is a unit length of the spatial domain, and b is a unit length of the spatial frequency domain.

4. The method as claimed in claim 2, wherein u is an integer closest to q.

5. The method as claimed in claim 3, wherein a relationship between the second pattern distribution and the first spatial frequency spectrum distribution is expressed as:
$$B ( l b , mb ) = {\sum }_{r = 0}^{N - 1} {\sum }_{s = 0}^{N - 1} {A}^{′} ( ra , sa ) exp ( - 2 π i \frac{( r l + m s )}{u} ) ,$$
wherein B(lb, mb) is the first spatial frequency spectrum distribution, A′(ra, sa) is the second pattern distribution,
wherein r, s, l, m are positive integers or 0, ra and sa are coordinates in the spatial domain, and/b and mb are coordinates in the spatial frequency domain,
wherein u is expressed as: u=q/σ,
wherein N is the number of pixels on a coordinate axis of the spatial domain.

6. The method as claimed in claim 1, wherein a relationship between the first spatial frequency spectrum distribution and the second spatial frequency spectrum distribution is expressed as:
B′(lb, mb)=P(lb, mb)B(lb, mb),
wherein B(lb, mb) is the first spatial frequency spectrum distribution, B′(lb, mb) is the second spatial frequency spectrum distribution, P(lb, mb) is the pupil function, and lb, mb are coordinates in the spatial frequency domain.

7. The method as claimed in claim 6, wherein the pupil function is expressed as:
$$P ( l b , mb ) = \{ \begin{matrix}= 1 , & {( {( l b )}^{2} + {( mb )}^{2} )}^{1 / 2} \leq \frac{NA}{λ} \\ = 0 , & {( {( l b )}^{2} + {( mb )}^{2} )}^{1 / 2} > \frac{NA}{λ}\end{matrix} ,$$
wherein NA is a numerical aperture of a projection lens of an optical system, and λ is a wavelength of a light emitted by the optical system.

8. The method as claimed in claim 7, wherein the numerical aperture is expressed as:
NA=n sin θ,
where n is a refractive index of the projection lens, and θ is a maximum angle between the light and an optical axis of the projection lens when the light is incident on the projection lens.

9. The method as claimed in claim 1, wherein a relationship between the second spatial frequency spectrum distribution and the first diffraction image distribution is expressed as:
$${C}^{′} ( ra , sa ) = {\sum }_{l = 0}^{N - 1} {\sum }_{m = 0}^{N - 1} {B}^{′} ( l b , mb ) exp ( 2 π i \frac{( r l + m s )}{u} ) ,$$
wherein B′(lb, mb) is the second spatial frequency spectrum distribution, C′(ra, sa) is the first diffraction image distribution,
wherein r, s, l, m are positive integers or 0, ra, sa are coordinates in the spatial domain, and lb and mb are coordinates in the spatial frequency domain, wherein u=q/σ, q is expressed as: q=λ/ab, wherein a is a unit length of the spatial domain, b is a unit length of the spatial frequency domain, λ is a wavelength of a light emitted by an optical system, and N is the number of pixels on a coordinate axis of the spatial domain.

10. The method as claimed in claim 1, wherein a relationship between the first diffraction image distribution and the second diffraction image distribution is expressed as:
C(x, y)=C′(σx, σy)
wherein C′(σx, σy) is the first diffraction image distribution, C(x, y) is the second diffraction image distribution, and σ is the scaling constant.
